(19) United States
(12) Patent Application Publication
(10) Pub. No.: US 2025/0350979 A1
(43) Pub. Date: Nov. 13, 2025

(54) TECHNIQUES FOR DYNAMIC DELAY STATUS REPORTING PROCEDURES

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 18/657,353

(22) Filed: May 7, 2024

(51) Int. Cl. H04W 24/10; H04B 17/364

(52) U.S. Cl. CPC H04W 24/10; H04B 17/364

(57) ABSTRACT

Methods, systems, and devices for wireless communications are described. A user equipment (UE) may dynamically trigger a delay status reporting procedure based on multiple delay status reporting triggers. For example, the UE may receive, from a network entity of a serving cell of the UE, a delay status reporting configuration including an indication of multiple triggering events associated with delay status reporting for one or more logical channels of the UE. The UE may transmit, in accordance with the delay status reporting configuration, a report indicative of a delay status of a first logical channel of the one or more logical channels based on a first triggering event of the multiple triggering events being satisfied. The UE may select the first triggering event from the multiple triggering events based on a radio condition associated with the UE, a traffic pattern associated with the first logical channel, or both.

### FIELD OF TECHNOLOGY

The following relates to wireless communications, including techniques for dynamic delay status reporting (DSR) procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). The UE may perform a delay status reporting (DSR) procedure to report buffers of one or more logical channels. The UE may perform the DSR procedure based on a DSR threshold.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity of a serving cell of the UE, a delay status reporting (DSR) configuration including an indication of a set of multiple triggering events associated with DSR for one or more logical channels of the UE and transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

A UE for wireless communications is described. The UE may include one or more memories storing processor executable code, and one or more processors coupled with the one or more memories. The one or more processors may individually or collectively be operable to execute the code to cause the UE to receive, from a network entity of a serving cell of the UE, a DSR configuration including an indication of a set of multiple triggering events associated with DSR for one or more logical channels of the UE and transmit, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

Another UE for wireless communications is described. The UE may include means for receiving, from a network entity of a serving cell of the UE, a DSR configuration including an indication of a set of multiple triggering events associated with DSR for one or more logical channels of the UE and means for transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

A non-transitory computer-readable medium storing code for wireless communications is described. The code may include instructions executable by one or more processors to receive, from a network entity of a serving cell of the UE, a DSR configuration including an indication of a set of multiple triggering events associated with DSR for one or more logical channels of the UE and transmit, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

Some examples of the method, UEs, and non-transitory computer-readable medium described herein may further include operations, features, means, or instructions for monitoring one or more performance indicators associated with the DSR, where the one or more performance indicators include a quantity of instances where any triggering event of the set of multiple triggering events may be satisfied, a quantity of instances where the DSR may be triggered, a scheduling request success rate, an average quantity of scheduling request transmissions before receiving a scheduling grant, a quantity of instances the DSR may be canceled, an effective packet data convergence protocol (PDCP) discard metric, or any combination thereof.

Some examples of the method, UEs, and non-transitory computer-readable medium described herein may further include operations, features, means, or instructions for transmitting, in accordance with the monitoring, a second report indicative of the one or more performance indicators associated with the DSR, where the DSR configuration may be received based on transmission of the second report.

Some examples of the method, UEs, and non-transitory computer-readable medium described herein may further include operations, features, means, or instructions for training an artificial intelligence model at the UE based on the one or more performance indicators associated with the DSR, where the first triggering event may be selected from the set of multiple triggering events based on the artificial intelligence model.

In some examples of the method, UEs, and non-transitory computer-readable medium described herein, the DSR configuration indicates a range of remaining time thresholds associated with a remaining time of a set of multiple PDCP timers associated with one or more service data units (SDUs) buffered for a logical channel group including the one or more logical channels of the UE, and the first triggering event includes a remaining time threshold of the range of remaining time thresholds selected by the UE based on the radio condition associated with the UE, the traffic pattern associated with the first logical channel, or both.

In some examples of the method, UEs, and non-transitory computer-readable medium described herein, transmitting the report indicative of the delay status may include operations, features, means, or instructions for transmitting the report indicative of the delay status of the first logical channel periodically based on the first triggering event of the set of multiple triggering events being satisfied and based on a DSR timer of the UE associated with the periodic transmission.

In some examples of the method, UEs, and non-transitory computer-readable medium described herein, the traffic pattern includes a traffic type of the first logical channel, bearer-specific data of the first logical channel, a quality of service (QoS) flow identifier (QFI) of a QoS flow of the first logical channel, or any combination thereof.

Some examples of the method, UEs, and non-transitory computer-readable medium described herein may further include operations, features, means, or instructions for receiving, from the network entity of the serving cell of the UE, a second DSR configuration including a second indication of a second set of multiple triggering events associated with the DSR for a second logical channel of the UE, where the first logical channel and the second logical channel may be of a same logical channel group.

In some examples of the method, UEs, and non-transitory computer-readable medium described herein, transmitting the report may include operations, features, means, or instructions for transmitting the report indicative of the delay status of the first logical channel the report prior to multiple of the set of multiple triggering events being satisfied based on the radio condition associated with the UE, the traffic pattern associated with the first logical channel, or both, where: the radio condition, the traffic pattern, or both may be associated with an uplink grant pattern, a type of data arrival, a burstiness of the data arrival, one or more characteristics of a packet data unit (PDU) set, or any combination thereof.

In some examples of the method, UEs, and non-transitory computer-readable medium described herein, the radio condition, the traffic pattern, or both may be associated with a signaling procedure at the UE, a bearer type, or both.

In some examples of the method, UEs, and non-transitory computer-readable medium described herein, transmitting the report may include operations, features, means, or instructions for transmitting the report indicative of the delay status of the first logical channel after a time delay based on the traffic pattern, where the traffic pattern includes a medium access control (MAC)-control element (CE), upper-layer traffic in a MAC transport block (TB), or both associated with a higher priority level than a priority level of the report.

In some examples of the method, UEs, and non-transitory computer-readable medium described herein, the report may be transmitted via a first component carrier and the method, apparatuses, and non-transitory computer-readable medium may include further operations, features, means, or instructions for transmitting, via a second component carrier, one or more retransmissions of the report indicative of the delay status of the first logical channel based on the radio condition associated with the UE, where the radio condition includes a hybrid automatic repeat request (HARQ) block error rate (BLER) of the UE.

In some examples of the method, UEs, and non-transitory computer-readable medium described herein, the report includes a MAC-CE.

A method for wireless communications by a network entity is described. The method may include outputting a DSR configuration including an indication of a set of multiple triggering events associated with a DSR for one or more logical channels of a UE and obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

A network entity for wireless communications is described. The network entity may include one or more memories storing processor executable code, and one or more processors coupled with the one or more memories. The one or more processors may individually or collectively be operable to execute the code to cause the network entity to output a DSR configuration including an indication of a set of multiple triggering events associated with a DSR for one or more logical channels of a UE and obtain, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

Another network entity for wireless communications is described. The network entity may include means for outputting a DSR configuration including an indication of a set of multiple triggering events associated with a DSR for one or more logical channels of a UE and means for obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

A non-transitory computer-readable medium storing code for wireless communications is described. The code may include instructions executable by one or more processors to output a DSR configuration including an indication of a set of multiple triggering events associated with a DSR for one or more logical channels of a UE and obtain, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

Some examples of the method, network entities, and non-transitory computer-readable medium described herein may further include operations, features, means, or instructions for receiving a second report indicative of one or more performance indicators associated with the DSR, where outputting the DSR configuration may be based on receiving the second report.

Some examples of the method, network entities, and non-transitory computer-readable medium described herein may further include operations, features, means, or instructions for training an artificial intelligence model based on the one or more performance indicators associated with the DSR, where the DSR configuration may be based on the artificial intelligence model.

Some examples of the method, network entities, and non-transitory computer-readable medium described herein may further include operations, features, means, or instructions for outputting a scheduling grant based on the one or more performance indicators, where the report may be received based on transmission of the scheduling grant.

In some examples of the method, network entities, and non-transitory computer-readable medium described herein, the one or more performance indicators include a quantity of instances, any triggering event of the set of multiple triggering events may be satisfied, a quantity of instances, and the DSR may be triggered, a scheduling request success rate, an average quantity of scheduling request transmissions before transmitting a scheduling grant, a quantity of instances the DSR may be canceled, an effective PDCP discard metric, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support techniques for dynamic delay status reporting (DSR) procedures in accordance with one or more aspects of the present disclosure.

FIG. 3 shows an example of a process flow that supports techniques for dynamic DSR procedures in accordance with one or more aspects of the present disclosure.

FIGS. 4 and 5 show block diagrams of devices that support techniques for dynamic DSR procedures in accordance with one or more aspects of the present disclosure.

FIG. 6 shows a block diagram of a communications manager that supports techniques for dynamic DSR procedures in accordance with one or more aspects of the present disclosure.

FIG. 7 shows a diagram of a system including a device that supports techniques for dynamic DSR procedures in accordance with one or more aspects of the present disclosure.

FIGS. 8 and 9 show block diagrams of devices that support techniques for dynamic DSR procedures in accordance with one or more aspects of the present disclosure.

FIG. 10 shows a block diagram of a communications manager that supports techniques for dynamic DSR procedures in accordance with one or more aspects of the present disclosure.

FIG. 11 shows a diagram of a system including a device that supports techniques for dynamic DSR procedures in accordance with one or more aspects of the present disclosure.

FIGS. 12 through 15 show flowcharts illustrating methods that support techniques for dynamic DSR procedures in accordance with one or more aspects of the present disclosure.

### DETAILED DESCRIPTION

Various aspects relate generally to wireless communication. Some aspects more specifically relate to delay status reporting (DSR) procedures. In some examples, a user equipment (UE) may perform a DSR procedure based on a DSR configuration. For example, the UE may receive the DSR configuration including multiple triggering events associated with DSR for one or more logical channels of the UE. The UE may select, from the multiple triggering events, a first triggering event. As an example, one or more of the multiple triggering events may be a range of remaining time thresholds associated with a remaining time of a packet data convergence protocol (PDCP) timers associated with service data units (SDUs) buffered for a logical channel group including the one or more logical channels. The UE may select the first triggering event as a remaining time threshold from the range of remaining time thresholds. In some examples, the UE may select the first triggering event based on a radio condition, a traffic pattern associated with a logical channel, or both. For example, the UE may select the first triggering event based on a location of the UE within a cell, signaling bearer procedures, a type of data, or the like. Based on selecting the first triggering event, the UE may transmit a report indicative of a delay status of the logical channel based on the first triggering event being satisfied. The report indicative of the delay status may provide information, to a network entity, about a quantity of logical channel data in buffer such that the network entity may schedule resources for communication of the logical channel data prior to expiration of a timer. For example, the report indicative of the delay status of the logical channel may indicate a remaining time, which may be a smallest remaining value of PDCP discard timers among SDUs buffered for the first logical channel (e.g., or a first logical channel group). Additionally, the report may indicate an amount of delay-critical uplink data for the first logical channel, such as in accordance with a data volume calculation procedure. The DSR procedure may be used to provide the network entity of a serving cell of the UE with a delay status of logical channel groups of the UE, which the network entity may use the information about the delay status to schedule the UE.

Particular aspects of the subject matter described in this disclosure can be implemented to realize one or more of the following potential advantages. In some examples, by selecting the first triggering event from multiple triggering events included in the DSR configuration, the described techniques can be used to improve a radio resource management (RRM) of the UE. For example, by including multiple triggering events in the DSR configuration, the UE may have a greater level of flexibility associated with triggering the DSR procedure. The UE may dynamically select and apply triggering events in response to radio conditions or traffic patterns, which may improve the RRM of the UE compared to the DSR configuration indicating a single triggering event, such as a single remaining time threshold.

Aspects of the disclosure are initially described in the context of wireless communications systems. Aspects of the disclosure are also described in the context of a process flow. Aspects of the disclosure are further illustrated by and described with reference to apparatus diagrams, system diagrams, and flowcharts that relate to techniques for dynamic DSR procedures.

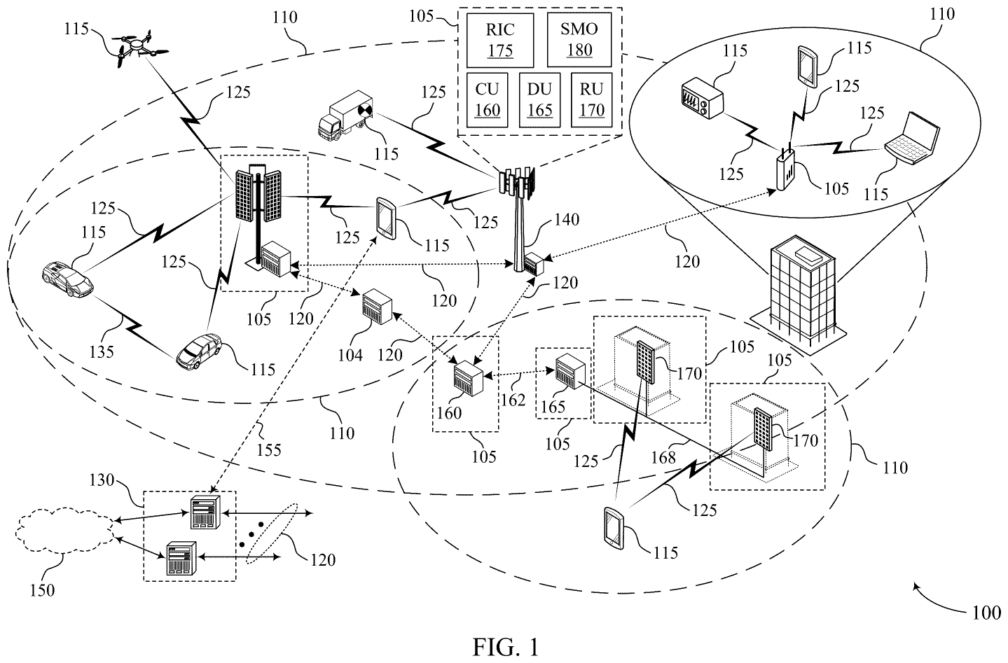

FIG. 1 shows an example of a wireless communications system 100 that supports techniques for dynamic DSR procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), PDCP). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the UE 115 may perform a DSR procedure according to a DSR configuration. For example, the UE 115 may receive, from the network entity 105 of a serving cell of the UE 115, a DSR configuration including an indication of multiple triggering events associated with DSR for one or more logical channels of the UE 115. Based on the DSR configuration, the UE 115 may transmit a report indicative of a delay status of a first logical channel of the one or more logical channels based on a first triggering event of the multiple triggering events being satisfied. For example, the UE 115 may select the first triggering event from the multiple triggering events based on a radio condition associated with the UE 115, a traffic pattern associated with the first logical channel, or both. By selecting the first triggering event from the multiple triggering events of the DSR configuration, the UE 115 may perform a dynamic DSR procedure and improve a RRM.

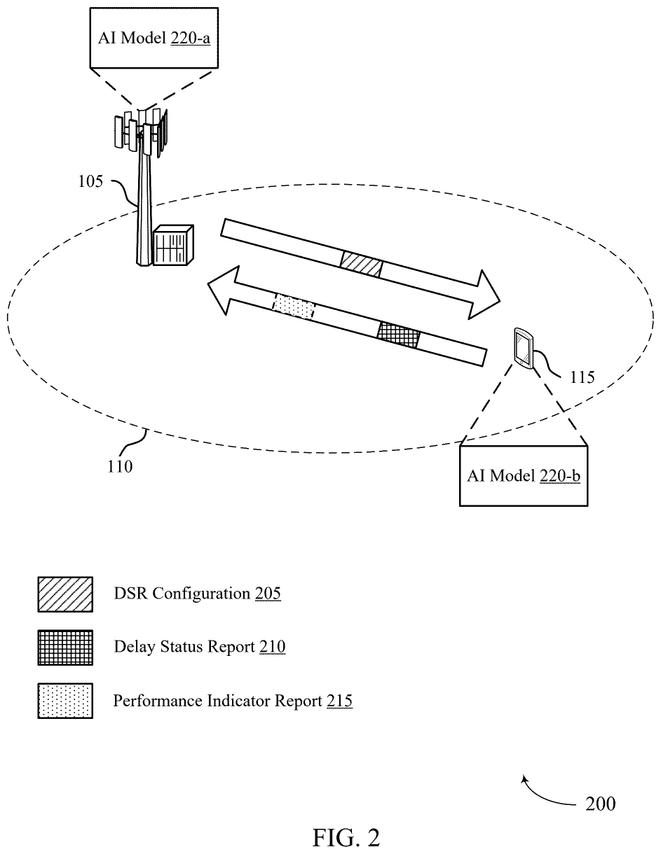

FIG. 2 shows an example of a wireless communications system 200 that supports techniques for dynamic DSR procedures in accordance with one or more aspects of the present disclosure. The wireless communications system 200 may implement or be implemented by various aspects of the wireless communications system 100. For example, the wireless communications system 200 may include a network entity 105 and a UE 115 in a coverage area 110, which may be examples of the network entity 105, the UE 115, and the coverage area 110, respectively, as described with reference to FIG. 1.

The wireless communications system 100 may support flexible triggering events for DSR at the UE 115, where a network entity may configure a set of triggering events and the UE 115 may select one or more triggering events from the set. In some cases, the UE 115 may transmit a DSR after determining a condition associated with any selected triggering event is satisfied. For example, the network entity 105 may output a DSR configuration 205 to the UE 115 indicating multiple triggering events. In some examples, the DSR configuration 205 may indicate a range of remaining time thresholds (e.g., remainingTimeThreshold), such as a minimum remaining time threshold and a maximum remaining time threshold, or multiple remaining time thresholds. A remaining time may be a smallest remaining value of multiple PDCP timers (e.g., discardTimers) among SDUs buffered for a logical channel group. The DSR configuration 205 may include an index indicative of the range or multiple remaining time thresholds.

Additionally, or alternatively, the DSR configuration 205 may include multiple triggers such that the UE 115 may periodically send reports indicative of delay status, such as based on a timer. For example, the DSR configuration 205 may enable the UE 115 to transmit a report indicative of the delay status of a logical channel associated with the DSR configuration 205, such as a delay status report 210, periodically based on a delay status reporting timer of the UE 115 associated with periodic transmission. That is, the UE 115 may transmit the delay status report 210 based on periodic expiration of the delay status reporting timer. The UE 115 may select a duration of the delay status reporting timer, such as from a range of delay status reporting time durations provided in the DSR configuration 205, based on radio conditions, traffic patterns, or both.

In some implementations, the DSR configuration 205 may include multiple triggering events which the UE 115 may select (e.g., apply for a DSR procedure) based on a type of traffic presence, bearer-specific data, or a Quality of Service (QoS) flow identifier (QFI). In other words, the DSR configuration 205 may indicate triggering events, where the UE 115 may select the triggering events based on a traffic pattern including a traffic type of the logical channel associated with the DSR configuration 205, bearer-specific data of the logical channel, a QFI of a QoS flow of the logical channel, or any combination thereof. The type of traffic may include video streaming, download, video call, or the like. In some examples, different radio bearers of the UE 115 may be associated with different data streams, including data streams with varying priority levels. The UE 115 may select one or more triggering events to prioritize a data stream of a first radio bearer. As an example, the UE 115 may select the one or more triggering events to prioritize a video call on the first radio bearer.

In some aspects, the network entity 105 may configure DSR per logical channel (e.g., rather than logical channel group). For example, the UE 115 may perform a DSR procedure with logical channel-level granularity (e.g., optionally). The network entity 105 may output multiple DSR configurations to the UE 115 corresponding to respective logical channels. For example, the DSR configuration 205 may correspond to a first logical channel and may include a first set of triggering events, a second DSR configuration may correspond to a second logical channel and may include a second set of triggering events, and so on, where the first logical channel and the second logical channel may be of a same logical channel group. Alternatively, the DSR configuration 205 may correspond to all logical channels of a logical channel group. For example, the DSR configuration 205 may correspond to the first logical channel and the second logical channel of the logical channel group and may include a same set of triggering events for the logical channels of the logical channel group.

The network entity 105 may configure the UE 115 to send DSR based on UE-specific events or knowledge. For example, the UE 115 may transmit the delay status report 210 (e.g., indicate DSR) early or late (e.g., compared to other triggering events) to the network entity 105. In some examples, the UE 115 may transmit the delay status report 210 early or late to improve grant scheduling aspects at the network entity 105. As an example, the UE 115 may transmit the delay status report 210 early based on a location of the UE 115 at an edge of a cell (e.g., at an edge of the coverage area 110) where a coverage level of the network entity 105 may be reduced. That is, the UE 115 may transmit the delay status report 210 early to help a scheduler of the network entity 105 refine grant management.

Additionally, or alternatively, the UE 115 may transmit the delay status report 210 based on a signaling bearer procedure or measurement triggering events which trigger the DSR at the UE 115. For example, the UE 115 may trigger DSR based on an ongoing signaling procedure, measurement events, or a bearer type, such as based on whether a bearer is a signaling radio bearer (SRB) or a data radio bearer (DRB). As examples, the UE 115 may trigger DSR based on a handover to another cell (e.g., triggering event based on a location of the UE 115 within the serving cell) or based on a handshake procedure (e.g., handshake triggering event). In some aspects, the UE 115 may skip transmission of the delay status report 210 in a MAC transport block (TB) based on a type of data. In other words, the UE 115 may refrain from transmitting the delay status report 210 when a triggering event is satisfied based on a type of data.

The UE 115 may determine and trigger DSR autonomously. In some examples, the UE 115 may include the delay status report 210 in a MAC-control element (CE), in an uplink scheduling message, or in a scheduling request procedure based on a selected triggering event being satisfied. The UE 115 may select or apply a triggering event of the multiple triggering events indicated in the DSR configuration 205. For example, the UE 115 may trigger DSR early, such as transmit the delay status report 210 early relative to other triggering events indicated in the DSR configuration 205.

The UE 115 may transmit the delay status report 210 early based on radio conditions at the UE 115 (e.g., a radio condition triggering event) or an uplink grant pattern (e.g., an uplink grant pattern triggering event). For example, the UE 115 may transmit the delay status report 210 early to account for poor radio conditions (e.g., a triggering event associated with signal quality falling below a threshold, such as reference signal receive power (RSRP)), and based on a delay requirement of data on the logical channel (e.g., delay triggering threshold). Or, the UE 115 may transmit the delay status report 210 early if the delay requirement of the data on the logical channel is not met and an uplink grant is not expected to be received (i.e., according to the uplink grant pattern). In some examples, the DSR configuration 205 may indicate a range or multiple RSRP thresholds as triggering events where the UE 115 may select a RSRP threshold as a triggering event. In an example, the UE 115 may transmit the delay status report 210 when a measured RSRP falls below the selected RSRP. In another example, the DSR configuration 205 may indicate a range or multiple time thresholds as triggering events where the UE 115 may select a particular time threshold as a triggering event. Logical channel data may be associated with a packet delay budget during which the logical channel data is to be successfully communicated between the UE 115 and the network entity 105. The range or multiple time thresholds may correspond to a remaining amount of time within the packet delay budget for completing the successfully communication of the logical channel data. When the remaining amount of time is less than the selected time threshold, the UE 115 may be triggered to send the delay status report 210 to request additional resources for scheduling transmission of the logical channel data in an attempt to successfully communicate the logical channel data before the packet delay budget expires.

Additionally, or alternatively, the UE 115 may transmit the delay status report 210 early based on a type of data arrival and a burstiness of the arrival. In other words, the triggering event may be associated with early transmission of the delay status report 210 relative to other triggering events, such as associated with a shorter delay status reporting timer duration. The UE 115 may select the triggering event based on traffic conditions on the logical channel, including the type of data arrival and the burstiness of the arrival. For example, when the data on the logical channel is being delayed due to increases in activity on the logical channel (e.g., burstiness), the UE 115 may transmit the delay status report 210 early to compensate for the increased activity. The selected triggering event may correspond to an amount of buffered data of a particular type, and the UE 115 may determine that the triggering event is satisfied for sending the DSR when the amount of buffered data meets or exceeds the threshold. In some examples, the UE 115 may transmit the delay status report 210 early based on triggering events associated with one or more of protocol data unit (PDU) set characteristics, such as a PDU set delay budget (PSDB), a PDU set error rate (PSER), PDU set integrated handling information (PDIHI), a PDU session identity (PSI), forward error correction (FEC) knowledge, or the like. For example, the UE 115 may transmit the delay status report 210 early (e.g., be triggered to send the DSR) based on when the PDU set characteristics satisfy one or more requirements associated with the data on the logical channel. As an example, the data on the logical channel may be extended reality (XR) critical traffic, and the UE 115 may transmit the delay status report 210 early to ensure that the requirements of the XR critical traffic are met. For example, the UE 115 may determine that a triggering event is satisfied for sending the DSR when the amount of buffered XR data meets or exceeds a threshold associated with the triggering event.

In some examples, the UE 115 may transmit the delay status report 210 early or late, such as early or late relative to other triggering events indicated in the DSR configuration 205. In other words, the triggering event may be associated with early transmission of the delay status report 210 relative to other triggering events, such as associated with a shorter delay status reporting timer duration. For example, the UE 115 may transmit the delay status report 210 early or late based on a QoS of a traffic flow or a QFI. That is, the UE 115 may transmit the delay status report 210 early or late to prioritize or deprioritize traffic, such as according to a priority level of traffic compared to a priority level of the delay status report 210. In other words, the UE 115 may select the triggering event based on traffic conditions on the logical channel, including the QoS or QFI of a traffic flow.

The UE 115 may transmit the delay status report 210 frequently based on timer logics (e.g., periodic), which may be selected based on radio conditions, traffic conditions, or both. For example, the UE 115 may periodically transmit the delay status report 210 based on a delay status report timer at the UE 115. In other words, the triggering event may be expiration of the delay status report timer. The UE 115 may select a duration of the delay status report timer as the triggering event, based on the radio conditions, the traffic conditions, or both. In some examples, the UE 115 may select a shorter time duration for poor radio conditions, and a longer time duration for good radio conditions. In another example, the UE 115 may select a shorter time duration for data associated with a shorter packet delay budget, and a longer time duration for data associated with a longer packet delay budget.

In some examples, the UE 115 may use different scheduling request configurations or variations to scheduling request configuration parameters based on a triggering event. For example, the UE 115 may use different scheduling request configurations or scheduling request configuration parameters based on a triggering event selected by the UE 115, including periodic transmission, padding, a remaining time threshold, or the like.

The UE 115 may de-prioritize a DSR over a MAC-CE or upper-layer traffic in a MAC TB. In other words, the UE 115 may provision to deprioritize the DSR over the MAC-CE or the upper-layer traffic in the MAC TB. De-prioritizing the delay status report 210 may include refraining from transmitting the delay status report 210 or transmitting the delay status report 210 after a time delay, such as after transmission of the MAC-CE or upper-layer traffic in the MAC TB with a priority level higher than a priority level of the delay status report 210.

Additionally, or alternatively, the UE 115 may cancel the DSR (e.g., early) based on an internal state of the UE 115 and radio conditions at the UE 115. For example, the UE 115 may refrain from transmitting the delay status report 210, even in examples in which a triggering event (e.g., a remaining time threshold) is met. In some examples, the UE 115 may skip transmission of the delay status report 210 (e.g., skip DSR), even in the examples in which the triggering event is met. In other words, the UE 115 may continue to trigger DSR and transmit the delay status report 210 after skipping transmission of the delay status report 210 at an instance, or the UE 115 may cancel the DSR and refrain from transmitting delay status reports (e.g., until receipt of another DSR configuration).

In some examples, the UE 115 may skip or cancel the DSR based on improved radio conditions. That is, the UE 115 may determine that requirements associated with data on the logical channel are satisfied and additional scheduling is not necessary. Accordingly, the UE 115 may refrain from transmitting the DSR. In other words, the UE 115 may select a triggering event with conditions which are associated with a low probability of occurring such that the DSR may not be triggered based on the improved radio conditions.

The UE 115 may transmit the delay status report 210 multiple times. For example, the UE 115 may transmit duplicates of the delay status report 210 through different component carrier-based MAC TB in a same slot or across slots to increase a reliability level. In other words, the UE 115 may transmit the delay status report 210 via a first component carrier and a duplication of the delay status report via a second component carrier. In some examples, the UE 115 may repeat a transmission of the delay status report 210, such as a retransmission of the delay status report 210, based on HARQ success information or a probability of HARQ success (e.g., history of HARQ block error rate (BLER) of the UE 115).

In some implementations, the UE 115 may report DSR enhanced information. For example, the UE 115 may report bytes beyond a threshold remaining time configured by the DSR configuration 205 or selected by the UE 115 from a range of remaining time thresholds of the DSR configuration 205.

The UE 115 may monitor performance indicators, such as key performance indicators (KPIs) associated with the DSR procedures. In other words, the UE may monitor specific DSR-based KPI. The UE 115 may monitor UE performance via the performance indicators determine whether delay status reports are being transmitted appropriately. That is, the UE 115 may monitor performance indicators to determine whether an amount of delay status reports sent by the UE 115 yields scheduling for the UE 115 that satisfies latency requirements of data on logical channels. The performance indicators may include a quantity of instances (e.g., number of times) where any DSR triggering conditions are met. The quantity of instances where the DSR triggering conditions are met may be related to scheduling issues and possible packet discard, such as due to a load at the network entity 105, or related to a power headroom (PHR) of the UE 115. For example, the quantity of instances where the DSR triggering conditions are met may be related to the scheduling issues, which may lead to packet loss and may be based on a loading (e.g., overloading) of the cell. Or, the quantity of instances that the DSR triggering conditions are met may be based on a relatively low PHR of the UE 115.

Additionally, or alternatively, the performance indicators may include a quantity of instances (e.g., number of times) where UE 115 performs a DSR-triggered scheduling request procedure, which may be related to a load on scheduling request and scheduling request configuration requirements. In some implementations, the performance indicators may include a DSR-triggered scheduling request success rate, an average quantity of scheduling request transmissions prior to receiving a scheduling grant, or both. The DSR-triggered scheduling request success rate and the average quantity of scheduling request transmissions may be related to common commercial issues. In some examples, the performance indicators may include a quantity of instances (e.g., number of times) where a triggered DSR procedure is canceled, which may be related to a scheduling improvement from the network entity 105.

Additionally, or alternatively, the performance indicators may include a distribution of DSR across logical channel groups. In other words, the performance indicators may include respective quantities of DSR triggered for different logical channel groups. The distribution of DSR across the logical channel groups may be related to logical channel-to-logical channel group grouping, which may be improved by changing a priority of one or more logical channels for differential traffic handling. In some implementations, the performance indicators may include an effective PDCP discard metric, which may be related to DSR-based scheduler adaptive grant management or modification of a discard configuration. For example, the effective PDCP discard metric may be reduced based on the DSR-based scheduler adaptive grant management or modification of the discard configuration.

The UE 115 may train an artificial intelligence (AI) model 220-b based on the performance indicators. For example, the AI model 220-b may be an example of an AI or machine learning (ML) model. The UE 115 may input the performance indicators to the AI model 220-b. The AI model 220-b may produce, as an output based on being trained with the performance indicators, information associated with the DSR procedure (e.g., recommendations for triggering event selection by the UE 115). The UE 115 may use the AI model 220-b to refine the DSR procedure at the UE 115. For example, a behavior of the UE 115 may be adapted based on the AI model 220-b (e.g., AI/ML scheduler). Additionally, or alternatively, based on the AI model 220-b, the UE 115 may autonomously transmit the delay status report 210 for range of thresholds, multiple triggering events, or both. In some examples, the delay status report 210 may be specific to a logical channel or logical channel group. Transmitting the delay status report 210 based on the AI model 220-b for the range of thresholds, according to multiple triggering events, and for logical channels or logical channel groups may help satisfy a QoS threshold (e.g., QoS requirements) in light of varying radio conditions at the UE 115 and improve RRM aspects.

Additionally, or alternatively, the UE 115 may report the performance indicators to the network entity 105. For example, the UE 115 may transmit a performance indicator report 215 to the network entity 105. The network entity 105 may train an AI model 220-b based on the performance indicator report 215. For example, the network entity 105 may update (e.g., revise) RRM aspects, including adjusting DSR configurations to adapt to changing throughput thresholds (e.g., requirements) at the UE 115 through different grant scheduling patterns, configured bandwidths (e.g., BWP, carrier aggregation configuration, etc.) for the UE 115, or both. In some examples, the UE 115 may transmit the performance indicator report 215 based on a traffic pattern, a type of traffic, an importance level of traffic (e.g., packet data unit (PDU) set importance, transmission control protocol (TCP) slow start phase, XR critical traffic, etc.). For example, the UE 115 may transmit the performance indicator report 215 based on traffic characteristics to help the network entity 105 adapt scheduling policies accordingly.

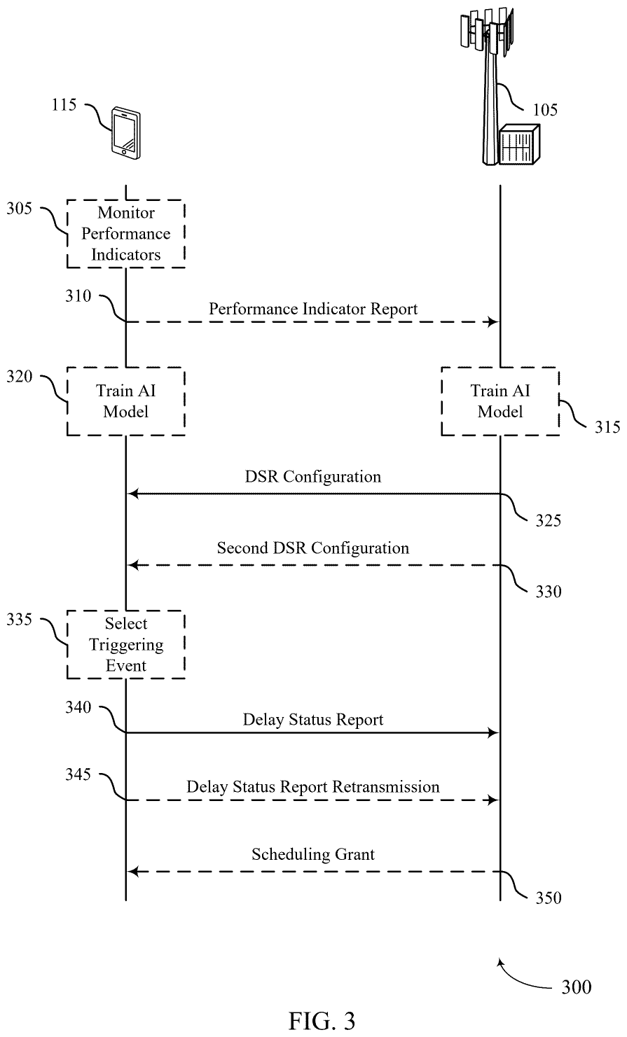

FIG. 3 shows an example of a process flow 300 that supports techniques for dynamic DSR procedures in accordance with one or more aspects of the present disclosure. In some examples, the process flow 300 may implement or be implemented by aspects of the wireless communications system 100, the wireless communications system 200, or both. For example, the process flow 300 may include a network entity 105 and a UE 115, which may be examples of corresponding devices as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the network entity 105 and the UE 115 are shown performing the operations of the process flow 300, some aspects of some operations may also be performed by one or more other wireless communication devices.

At 305, the UE 115 may monitor performance indicators. For example, the UE 115 may monitor one or more performance indicators (e.g., KPIs) associated with a DSR procedure. The one or more performance indicators may include a quantity of instances where any triggering event of multiple triggering events is satisfied (e.g., previously configured triggering events), a quantity of instances where the DSR procedure is triggered, a scheduling request success rate, an average quantity of scheduling request transmissions before receiving a scheduling grant, a quantity of instances the delay status reporting is canceled, an effective PDCP discard metric, or the like.

At 310, the UE 115 may transmit a performance indicator report to the network entity 105. For example, the performance indicator report may be an example of the performance indicator report 215 as described with reference to FIG. 2. The UE 115 may transmit a report indicative of the one or more performance indicators associated with the delay status reporting. After obtaining the report, at 315, the network entity 105 may train an AI model. For example, the AI model may be an example of the AI model 220-a as described with reference to FIG. 2. The network entity 105 may train the AI model based on the one or more performance indicators associated with the DSR. In some examples, the network entity 105 may determine (e.g., or update) a delay status reporting configuration based on the AI model. In some examples, the network entity 105 may output a scheduling grant based on the one or more performance indicators. For example, the network entity may adapt a scheduling policy based on obtaining the performance indicator report, based on the AI model, or both.

At 320, the UE 115 may train an AI model. The UE 115 may train the AI model in addition to or alternatively from transmitting the performance indicator report at 310. The AI model may be an example of the AI model 220-b as described with reference to FIG. 2. The UE 115 may train the AI model at the UE 115 based on the one or more performance indicators associated with the DSR. In some examples, the UE 115 may select triggering events based on the AI model.

At 325, the network entity 105 may output (e.g., transmit) a DSR configuration to the UE 115. For example, the DSR configuration may be an example of the DSR configuration 205 as described with reference to FIG. 2. The UE 115 may receive the DSR configuration including an indication of multiple triggering events associated with DSR for a first logical channel of the UE 115. In other words, the DSR configuration may include flexible DSR triggers or events. In some examples, the UE 115 may receive the DSR configuration based on transmitting the report indicative of the one or more performance indicators. In other words, the DSR configuration may be based on the AI model at the network entity 105, which may be trained according to the one or more performance indicators at 315.

In some examples, the DSR configuration may indicate a range of remaining time thresholds associated with a remaining time of multiple PDCP timers associated with one or more SDUs buffered for a logical channel group including the one or more logical channels of the UE 115. For example, the DSR configuration may include a minimum remaining time and a maximum remaining time.

At 330, the network entity 105 may output a second DSR configuration to the UE 115. For example, the UE 115 may receive a second DSR configuration including a second indication of second triggering events associated with DSR for a second logical channel of the UE 115, where the first logical channel and the second logical channel are of a same logical channel group. In other words, the network entity 105 may configure DSR triggers per logical channel (e.g., rather than logical channel group). That is, the UE 115 may receive separate DSR configurations for each logical channel at the UE 115.

At 335, the UE 115 may select a triggering event. For example, the UE 115 may select a triggering event from the multiple triggering events based on a radio condition associated with the UE 115, a traffic pattern associated with the first logical channel, or both. In some examples, the UE 115 may select the triggering event based on the AI model, such as the AI model trained at 320. In some examples, such as in examples in which the DSR configuration indicates the range of remaining time thresholds, the UE 115 may select a remaining time threshold from the range based on the radio condition, the traffic pattern, or both. Other triggering events that may be selected include a traffic type triggering event, a data latency triggering event, different triggering events respectively associated with each logical channel of a set of two or more logical channels of a logical channel group, a length of a time duration selected from a set of time durations for periodically sending a DSR, as well as other triggering events discussed herein.

The traffic pattern may include a traffic type of the first logical channel, bearer-specific data of the first logical channel, a QFI of a QoS flow of the first logical channel, or the like. Additionally, or alternatively, the radio condition, the traffic pattern, or both may be associated with a signaling procedure at the UE, a bearer type, or both.

At 340, the UE 115 may transmit a delay status report to the network entity 105. For example, the delay status report may be an example of the delay status report 210 as described with reference to FIG. 2. The UE 115 may transmit the delay status report in accordance with the DSR configuration received at 325. The delay status report may be indicative of a delay status of the first logical channel based on the triggering event being satisfied. For example, the UE 115 may transmit the delay status report based on the triggering event selected at 335 being satisfied.

In some examples, the UE 115 may transmit the delay status report in accordance with the selected remaining time threshold from the range of remaining time thresholds being satisfied. Additionally, or alternatively, the selected triggering event may be associated with periodic transmission of the DSR. In such examples, the UE 115 may transmit the delay status report periodically based on the triggering event being satisfied and based on a delay status reporting timer of the UE 115 associated with the periodic transmission.

In some implementations, the triggering event may be associated with early indication of the delay status. In such implementations, the UE 115 may transmit the delay status report prior to multiple of the triggering events being satisfied based on an uplink grant pattern, a type of data arrival, a burstiness of the data arrival, characteristics of a PDU set, or any combination thereof. Alternatively, the triggering event may be associated with late indication of the delay status. In such examples, the UE 115 may transmit the delay status report after a time delay based on a MAC-CE, upper-layer traffic in a MAC TB, or both associated with a higher priority level than a priority level of the report.

At 345, the UE 115 may transmit a delay status report retransmission to the network entity 105. For example, the UE 115 may transmit a duplication of the delay status report via a different component carrier than the delay status report transmitted at 345. That is, the UE 115 may transmit duplications of the delay status report via different component carriers. In some examples, the UE 115 may transmit a retransmission of the delay status report. For example, the UE 115 may transmit the retransmission based on a HARQ BLER of the UE 115.

At 350, the network entity 105 may output a scheduling grant to the UE 115. For example, the network entity 105 may output the scheduling grant based on the one or more performance indicators received at 310, in response to receiving the delay status report at 340 or at 345, or both. In some examples, the UE 115 may transmit a delay status report based on receiving the scheduling grant.

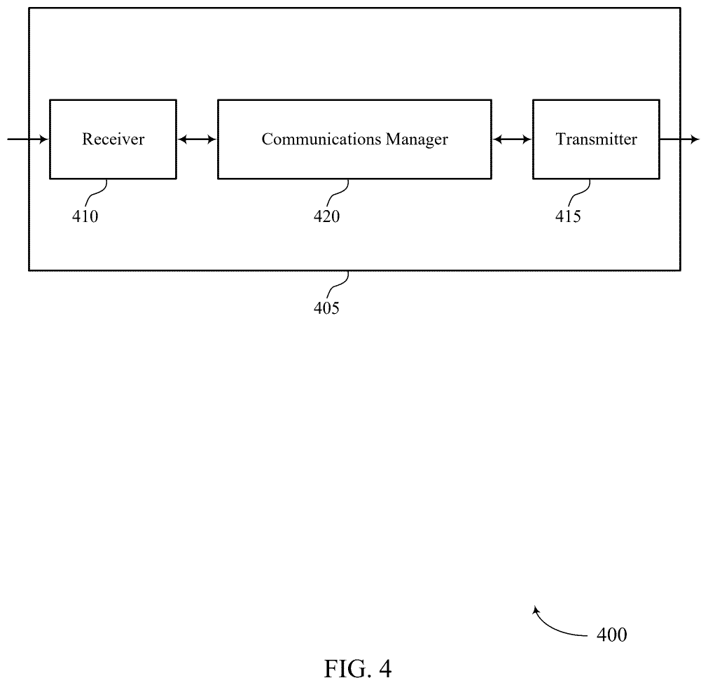

FIG. 4 shows a block diagram 400 of a device 405 that supports techniques for dynamic DSR procedures in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for dynamic DSR procedures). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for dynamic DSR procedures). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for dynamic DSR procedures as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity of a serving cell of the UE, a DSR configuration including an indication of a set of multiple triggering events associated with DSR for one or more logical channels of the UE. The communications manager 420 is capable of, configured to, or operable to support a means for transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

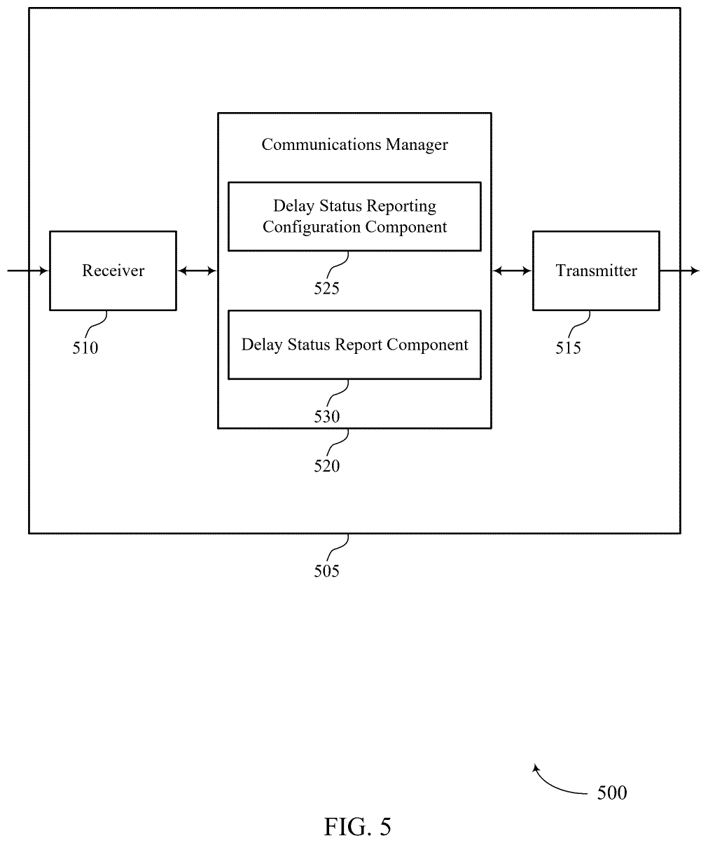

FIG. 5 shows a block diagram 500 of a device 505 that supports techniques for dynamic DSR procedures in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for dynamic DSR procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for dynamic DSR procedures). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for dynamic DSR procedures as described herein. For example, the communications manager 520 may include a DSR configuration component 525 a delay status report component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The DSR configuration component 525 is capable of, configured to, or operable to support a means for receiving, from a network entity of a serving cell of the UE, a DSR configuration including an indication of a set of multiple triggering events associated with DSR for one or more logical channels of the UE. The delay status report component 530 is capable of, configured to, or operable to support a means for transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

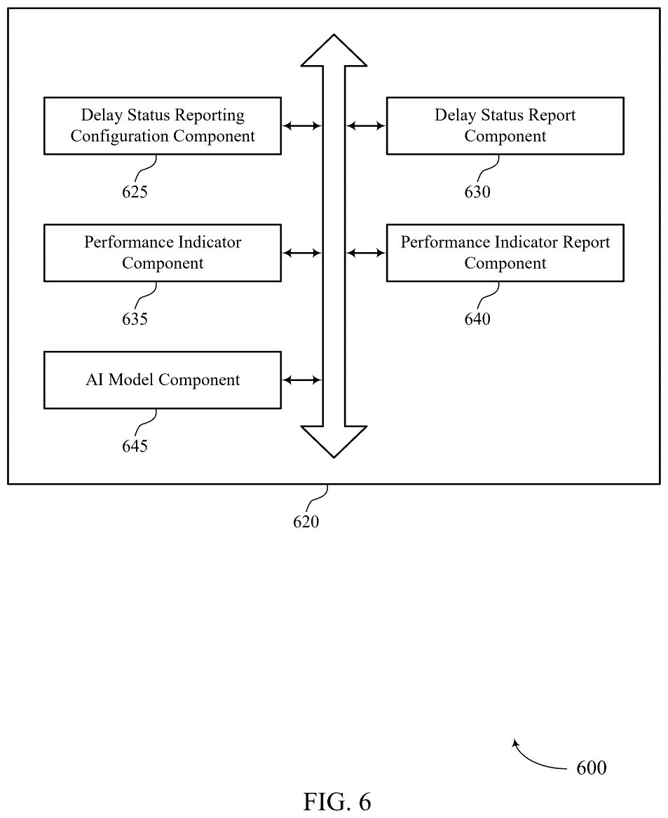

FIG. 6 shows a block diagram 600 of a communications manager 620 that supports techniques for dynamic DSR procedures in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for dynamic DSR procedures as described herein. For example, the communications manager 620 may include a DSR configuration component 625, a delay status report component 630, a performance indicator component 635, a performance indicator report component 640, an AI model component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The DSR configuration component 625 is capable of, configured to, or operable to support a means for receiving, from a network entity of a serving cell of the UE, a DSR configuration including an indication of a set of multiple triggering events associated with DSR for one or more logical channels of the UE. The delay status report component 630 is capable of, configured to, or operable to support a means for transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

In some examples, the performance indicator component 635 is capable of, configured to, or operable to support a means for monitoring one or more performance indicators associated with the DSR, where the one or more performance indicators include a quantity of instances where any triggering event of the set of multiple triggering events is satisfied, a quantity of instances where the DSR is triggered, a scheduling request success rate, an average quantity of scheduling request transmissions before receiving a scheduling grant, a quantity of instances the DSR is canceled, an effective PDCP discard metric, or any combination thereof.

In some examples, the performance indicator report component 640 is capable of, configured to, or operable to support a means for transmitting, in accordance with the monitoring, a second report indicative of the one or more performance indicators associated with the DSR, where the DSR configuration is received based on transmission of the second report.

In some examples, the AI model component 645 is capable of, configured to, or operable to support a means for training an AI model at the UE based on the one or more performance indicators associated with the DSR, where the first triggering event is selected from the set of multiple triggering events based on the AI model.

In some examples, the DSR configuration indicates a range of remaining time thresholds associated with a remaining time of a set of multiple PDCP timers associated with one or more SDUs buffered for a logical channel group including the one or more logical channels of the UE, and the first triggering event includes a remaining time threshold of the range of remaining time thresholds selected by the UE based on the radio condition associated with the UE, the traffic pattern associated with the first logical channel, or both.

In some examples, to support transmitting the report indicative of the delay status, the delay status report component 630 is capable of, configured to, or operable to support a means for transmitting the report indicative of the delay status of the first logical channel periodically based on the first triggering event of the set of multiple triggering events being satisfied and based on a DSR timer of the UE associated with the periodic transmission.

In some examples, the traffic pattern includes a traffic type of the first logical channel, bearer-specific data of the first logical channel, a QFI of a QoS flow of the first logical channel, or any combination thereof.

In some examples, the DSR configuration component 625 is capable of, configured to, or operable to support a means for receiving, from the network entity of the serving cell of the UE, a second DSR configuration including a second indication of a second set of multiple triggering events associated with the DSR for a second logical channel of the UE, where the first logical channel and the second logical channel are of a same logical channel group.

In some examples, to support transmitting the report, the delay status report component 630 is capable of, configured to, or operable to support a means for transmitting the report indicative of the delay status of the first logical channel the report prior to multiple of the set of multiple triggering events being satisfied based on the radio condition associated with the UE, the traffic pattern associated with the first logical channel, or both, where: the radio condition, the traffic pattern, or both are associated with an uplink grant pattern, a type of data arrival, a burstiness of the data arrival, one or more characteristics of a PDU set, or any combination thereof.

In some examples, the radio condition, the traffic pattern, or both are associated with a signaling procedure at the UE, a bearer type, or both.

In some examples, to support transmitting the report, the delay status report component 630 is capable of, configured to, or operable to support a means for transmitting the report indicative of the delay status of the first logical channel after a time delay based on the traffic pattern, where the traffic pattern includes a MAC-CE, upper-layer traffic in a MAC TB, or both associated with a higher priority level than a priority level of the report.

In some examples, the report is transmitted via a first component carrier, and the delay status report component 630 is capable of, configured to, or operable to support a means for transmitting, via a second component carrier, one or more retransmissions of the report indicative of the delay status of the first logical channel based on the radio condition associated with the UE, where the radio condition includes an HARQ BLER of the UE.

In some examples, the report includes a MAC-CE.

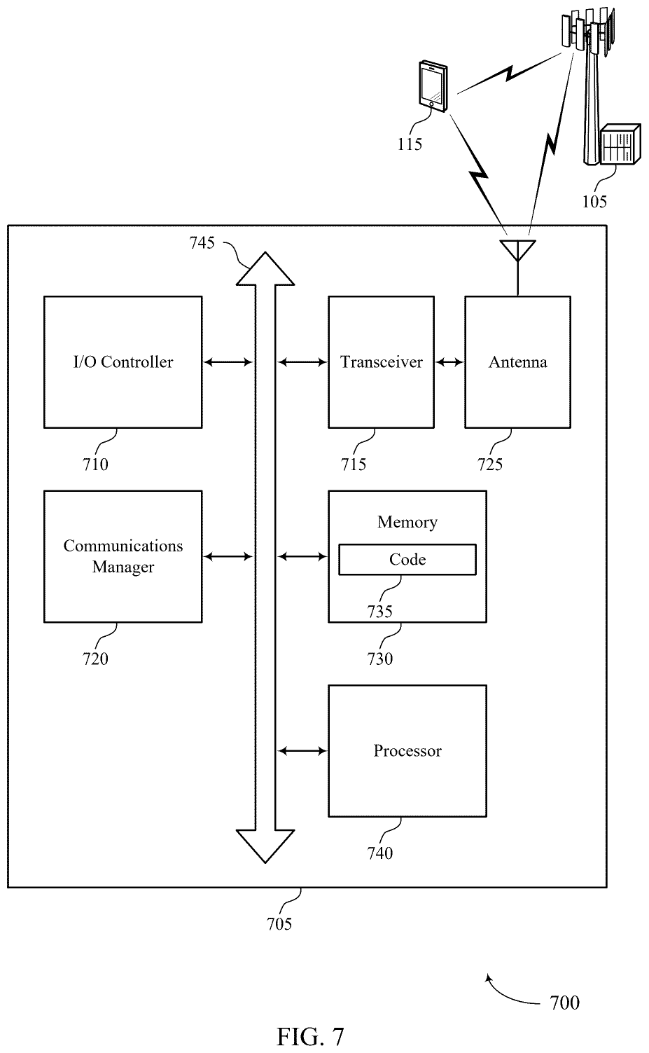

FIG. 7 shows a diagram of a system 700 including a device 705 that supports techniques for dynamic DSR procedures in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for dynamic DSR procedures). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity of a serving cell of the UE, a DSR configuration including an indication of a set of multiple triggering events associated with DSR for one or more logical channels of the UE. The communications manager 720 is capable of, configured to, or operable to support a means for transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for dynamic DSR procedures as described herein, or the at least one processor 740 and the at least one memory 730 may be otherwise configured to, individually or collectively, perform or support such operations.

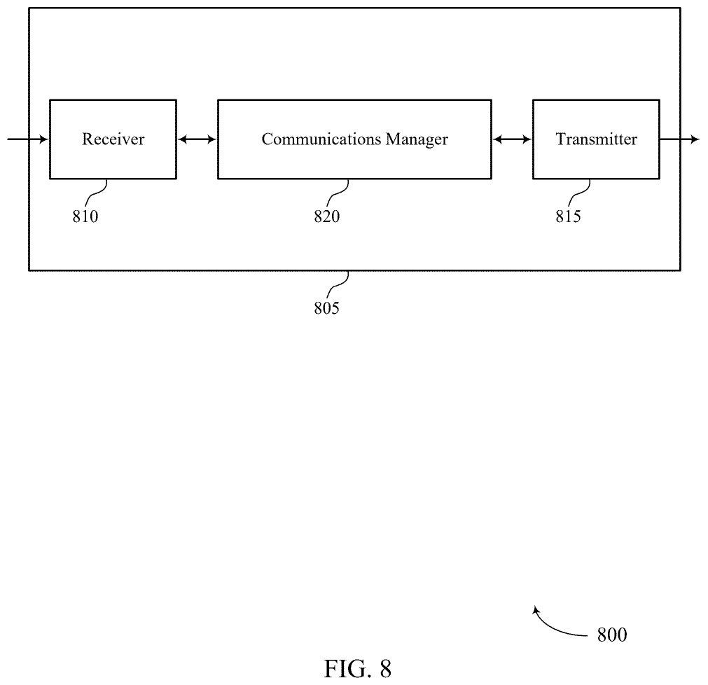

FIG. 8 shows a block diagram 800 of a device 805 that supports techniques for dynamic DSR procedures in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for dynamic DSR procedures as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a DSR configuration including an indication of a set of multiple triggering events associated with a DSR for one or more logical channels of a UE. The communications manager 820 is capable of, configured to, or operable to support a means for obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

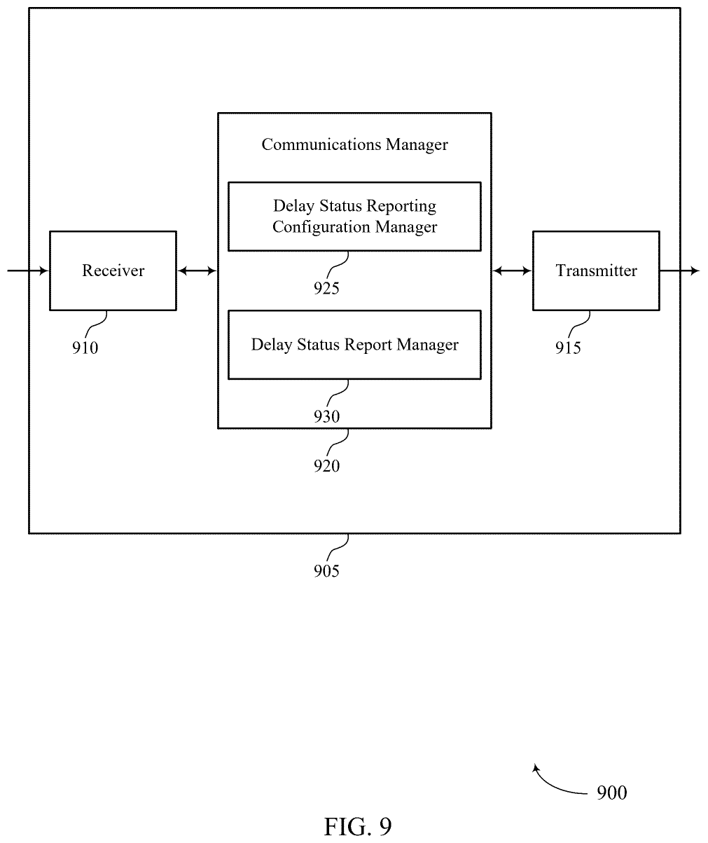

FIG. 9 shows a block diagram 900 of a device 905 that supports techniques for dynamic DSR procedures in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for dynamic DSR procedures as described herein. For example, the communications manager 920 may include a DSR configuration manager 925 a delay status report manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The DSR configuration manager 925 is capable of, configured to, or operable to support a means for outputting a DSR configuration including an indication of a set of multiple triggering events associated with a DSR for one or more logical channels of a UE. The delay status report manager 930 is capable of, configured to, or operable to support a means for obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

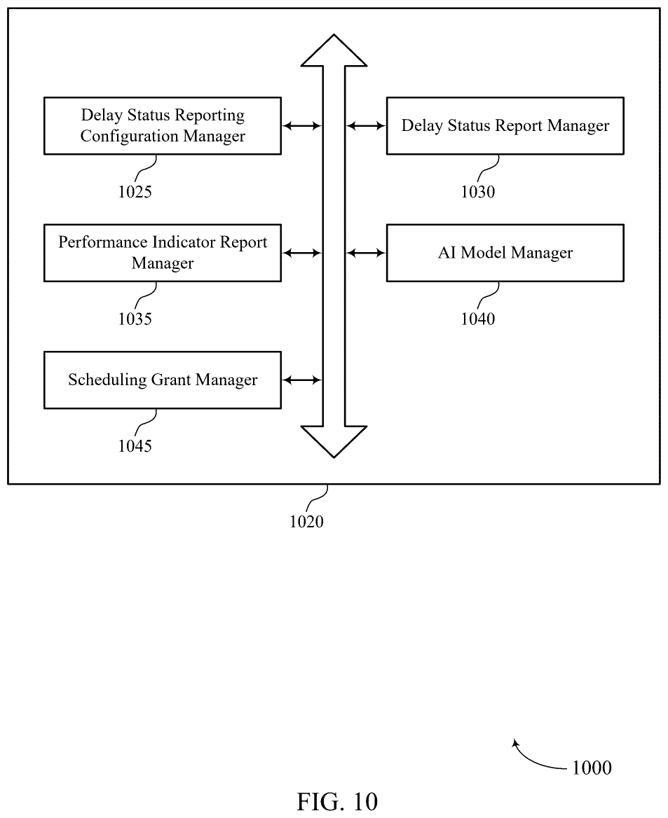

FIG. 10 shows a block diagram 1000 of a communications manager 1020 that supports techniques for dynamic DSR procedures in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for dynamic DSR procedures as described herein. For example, the communications manager 1020 may include a DSR configuration manager 1025, a delay status report manager 1030, a performance indicator report manager 1035, an AI model manager 1040, a scheduling grant manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The DSR configuration manager 1025 is capable of, configured to, or operable to support a means for outputting a DSR configuration including an indication of a set of multiple triggering events associated with a DSR for one or more logical channels of a UE. The delay status report manager 1030 is capable of, configured to, or operable to support a means for obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

In some examples, the performance indicator report manager 1035 is capable of, configured to, or operable to support a means for receiving a second report indicative of one or more performance indicators associated with the DSR, where outputting the DSR configuration is based on receiving the second report.

In some examples, the AI model manager 1040 is capable of, configured to, or operable to support a means for training an AI model based on the one or more performance indicators associated with the DSR, where the DSR configuration is based on the AI model.

In some examples, the scheduling grant manager 1045 is capable of, configured to, or operable to support a means for outputting a scheduling grant based on the one or more performance indicators, where the report is received based on transmission of the scheduling grant.

In some examples, the one or more performance indicators include a quantity of instances. In some examples, any triggering event of the set of multiple triggering events are satisfied, a quantity of instances. In some examples, the DSR is triggered, a scheduling request success rate, an average quantity of scheduling request transmissions before transmitting a scheduling grant, a quantity of instances the DSR is canceled, an effective PDCP discard metric, or any combination thereof.

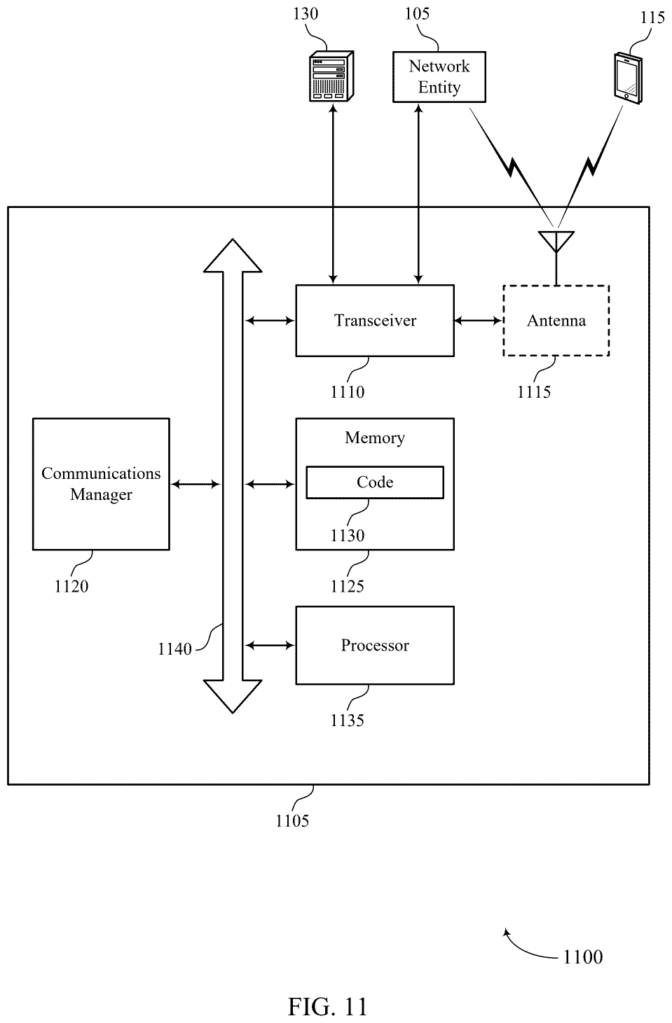

FIG. 11 shows a diagram of a system 1100 including a device 1105 that supports techniques for dynamic DSR procedures in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for dynamic DSR procedures). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a DSR configuration including an indication of a set of multiple triggering events associated with a DSR for one or more logical channels of a UE. The communications manager 1120 is capable of, configured to, or operable to support a means for obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both.

By including or configuring the communications manager 1120 in accordance with examples as described herein, the device 1105 may support techniques for improved communication reliability, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for dynamic DSR procedures as described herein, or the at least one processor 1135 and the at least one memory 1125 may be otherwise configured to, individually or collectively, perform or support such operations.

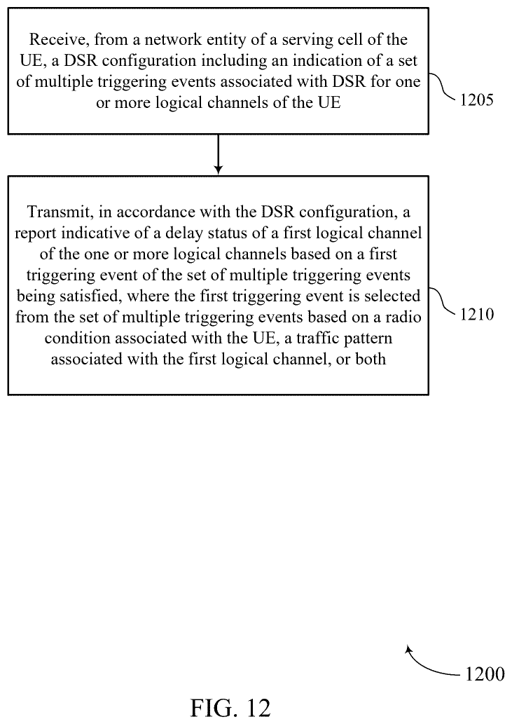

FIG. 12 shows a flowchart illustrating a method 1200 that supports techniques for dynamic DSR procedures in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity of a serving cell of the UE, a DSR configuration including an indication of a set of multiple triggering events associated with DSR for one or more logical channels of the UE. The operations of 1205 may be performed in accordance with examples as disclosed herein. In some examples, aspects of the operations of 1205 may be performed by a DSR configuration component 625 as described with reference to FIG. 6.

At 1210, the method may include transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both. The operations of 1210 may be performed in accordance with examples as disclosed herein. In some examples, aspects of the operations of 1210 may be performed by a delay status report component 630 as described with reference to FIG. 6.

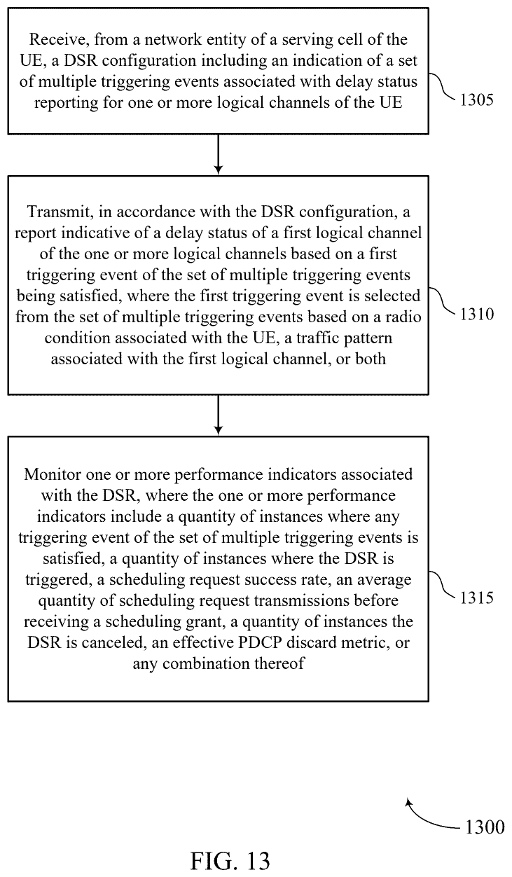

FIG. 13 shows a flowchart illustrating a method 1300 that supports techniques for dynamic DSR procedures in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity of a serving cell of the UE, a DSR configuration including an indication of a set of multiple triggering events associated with DSR for one or more logical channels of the UE. The operations of 1305 may be performed in accordance with examples as disclosed herein. In some examples, aspects of the operations of 1305 may be performed by a DSR configuration component 625 as described with reference to FIG. 6.

At 1310, the method may include transmitting, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both. The operations of 1310 may be performed in accordance with examples as disclosed herein. In some examples, aspects of the operations of 1310 may be performed by a delay status report component 630 as described with reference to FIG. 6.

At 1315, the method may include monitoring one or more performance indicators associated with the DSR, where the one or more performance indicators include a quantity of instances where any triggering event of the set of multiple triggering events is satisfied, a quantity of instances where the DSR is triggered, a scheduling request success rate, an average quantity of scheduling request transmissions before receiving a scheduling grant, a quantity of instances the DSR is canceled, an effective PDCP discard metric, or any combination thereof. The operations of 1315 may be performed in accordance with examples as disclosed herein. In some examples, aspects of the operations of 1315 may be performed by a performance indicator component 635 as described with reference to FIG. 6.

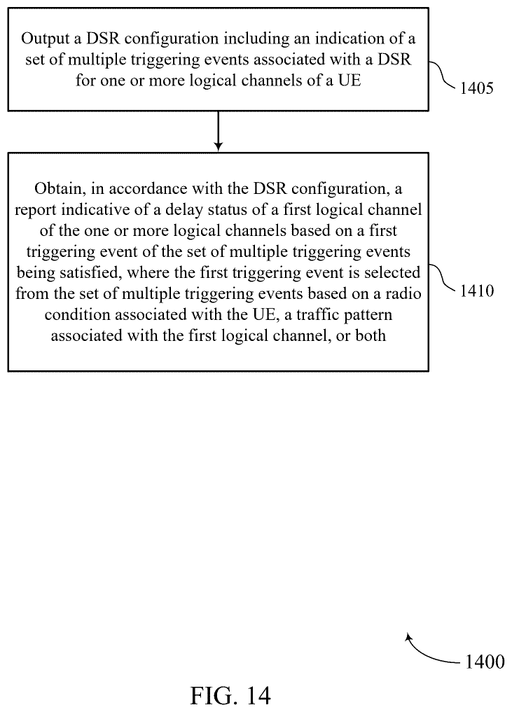

FIG. 14 shows a flowchart illustrating a method 1400 that supports techniques for dynamic DSR procedures in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting a DSR configuration including an indication of a set of multiple triggering events associated with a DSR for one or more logical channels of a UE. The operations of 1405 may be performed in accordance with examples as disclosed herein. In some examples, aspects of the operations of 1405 may be performed by a DSR configuration manager 1025 as described with reference to FIG. 10.

At 1410, the method may include obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both. The operations of 1410 may be performed in accordance with examples as disclosed herein. In some examples, aspects of the operations of 1410 may be performed by a delay status report manager 1030 as described with reference to FIG. 10.

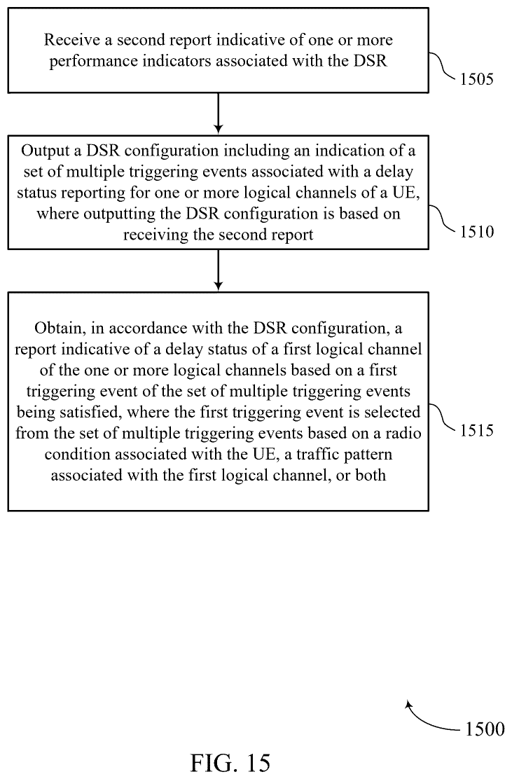

FIG. 15 shows a flowchart illustrating a method 1500 that supports techniques for dynamic DSR procedures in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving a second report indicative of one or more performance indicators associated with the DSR. The operations of 1505 may be performed in accordance with examples as disclosed herein. In some examples, aspects of the operations of 1505 may be performed by a performance indicator report manager 1035 as described with reference to FIG. 10.

At 1510, the method may include outputting a DSR configuration including an indication of a set of multiple triggering events associated with a DSR for one or more logical channels of a UE, where outputting the DSR configuration is based on receiving the second report. The operations of 1510 may be performed in accordance with examples as disclosed herein. In some examples, aspects of the operations of 1510 may be performed by a DSR configuration manager 1025 as described with reference to FIG. 10.

At 1515, the method may include obtaining, in accordance with the DSR configuration, a report indicative of a delay status of a first logical channel of the one or more logical channels based on a first triggering event of the set of multiple triggering events being satisfied, where the first triggering event is selected from the set of multiple triggering events based on a radio condition associated with the UE, a traffic pattern associated with the first logical channel, or both. The operations of 1515 may be performed in accordance with examples as disclosed herein. In some examples, aspects of the operations of 1515 may be performed by a delay status report manager 1030 as described with reference to FIG. 10.

The following provides an overview of aspects of the present disclosure:

Aspect 1: A method for wireless communications at a UE, comprising: receiving, from a network entity of a serving cell of the UE, a DSR configuration comprising an indication of a plurality of triggering events associated with DSR for one or more logical channels of the UE; and transmitting, in accordance with the DSR configuration, a report indicative of a delay status of a first logical channel of the one or more logical channels based at least in part on a first triggering event of the plurality of triggering events being satisfied, wherein the first triggering event is selected from the plurality of triggering events based at least in part on a radio condition associated with the UE, a traffic pattern associated with the first logical channel, or both.

Aspect 2: The method of aspect 1, further comprising: monitoring one or more performance indicators associated with the DSR, wherein the one or more performance indicators comprise a quantity of instances wherein any triggering event of the plurality of triggering events is satisfied, a quantity of instances wherein the DSR is triggered, a scheduling request success rate, an average quantity of scheduling request transmissions before receiving a scheduling grant, a quantity of instances the DSR is canceled, an effective PDCP discard metric, or any combination thereof.

Aspect 3: The method of aspect 2, further comprising: transmitting, in accordance with the monitoring, a second report indicative of the one or more performance indicators associated with the DSR, wherein the DSR configuration is received based at least in part on transmission of the second report.

Aspect 4: The method of any of aspects 2 through 3, further comprising: training an artificial intelligence model at the UE based at least in part on the one or more performance indicators associated with the DSR, wherein the first triggering event is selected from the plurality of triggering events based at least in part on the artificial intelligence model.

Aspect 5: The method of any of aspects 1 through 4, wherein the DSR configuration indicates a range of remaining time thresholds associated with a remaining time of a plurality of PDCP timers associated with one or more SDUs buffered for a logical channel group comprising the one or more logical channels of the UE, and the first triggering event comprises a remaining time threshold of the range of remaining time thresholds selected by the UE based at least in part on the radio condition associated with the UE, the traffic pattern associated with the first logical channel, or both.

Aspect 6: The method of any of aspects 1 through 5, wherein the first triggering event is associated with periodic transmission of the DSR, and wherein transmitting the report indicative of the delay status comprises: transmitting the report indicative of the delay status of the first logical channel periodically based at least in part on the first triggering event of the plurality of triggering events being satisfied and based at least in part on a DSR timer of the UE associated with the periodic transmission.

Aspect 7: The method of any of aspects 1 through 6, wherein the traffic pattern comprises a traffic type of the first logical channel, bearer-specific data of the first logical channel, a QFI of a QoS flow of the first logical channel, or any combination thereof.

Aspect 8: The method of any of aspects 1 through 7, further comprising: receiving, from the network entity of the serving cell of the UE, a second DSR configuration comprising a second indication of a second plurality of triggering events associated with the DSR for a second logical channel of the UE, wherein the first logical channel and the second logical channel are of a same logical channel group.

Aspect 9: The method of any of aspects 1 through 8, wherein the first triggering event is associated with early indication of the delay status, and wherein transmitting the report comprises: transmitting the report indicative of the delay status of the first logical channel the report prior to multiple of the plurality of triggering events being satisfied based at least in part on the radio condition associated with the UE, the traffic pattern associated with the first logical channel, or both, wherein: the radio condition, the traffic pattern, or both are associated with an uplink grant pattern, a type of data arrival, a burstiness of the data arrival, one or more characteristics of a PDU set, or any combination thereof.

Aspect 10: The method of any of aspects 1 through 9, wherein the radio condition, the traffic pattern, or both are associated with a signaling procedure at the UE, a bearer type, or both.

Aspect 11: The method of any of aspects 1 through 10, wherein transmitting the report comprises: transmitting the report indicative of the delay status of the first logical channel after a time delay based at least in part on the traffic pattern, wherein the traffic pattern comprises a MAC-CE, upper-layer traffic in a MAC TB, or both associated with a higher priority level than a priority level of the report.

Aspect 12: The method of any of aspects 1 through 11, wherein the report is transmitted via a first component carrier, the method further comprising: transmitting, via a second component carrier, one or more retransmissions of the report indicative of the delay status of the first logical channel based at least in part on the radio condition associated with the UE, wherein the radio condition comprises an HARQ BLER of the UE.

Aspect 13: The method of any of aspects 1 through 12, wherein the report comprises a MAC-CE.

Aspect 14: A method for wireless communications at a network entity, comprising: outputting a DSR configuration comprising an indication of a plurality of triggering events associated with a DSR for one or more logical channels of a UE; and obtaining, in accordance with the DSR configuration, a report indicative of a delay status of a first logical channel of the one or more logical channels based at least in part on a first triggering event of the plurality of triggering events being satisfied, wherein the first triggering event is selected from the plurality of triggering events based at least in part on a radio condition associated with the UE, a traffic pattern associated with the first logical channel, or both.

Aspect 15: The method of aspect 14, further comprising: receiving a second report indicative of one or more performance indicators associated with the DSR, wherein outputting the DSR configuration is based at least in part on receiving the second report.

Aspect 16: The method of aspect 15, further comprising: training an artificial intelligence model based at least in part on the one or more performance indicators associated with the DSR, wherein the DSR configuration is based at least in part on the artificial intelligence model.

Aspect 17: The method of any of aspects 15 through 16, further comprising: outputting a scheduling grant based at least in part on the one or more performance indicators, wherein the report is received based at least in part on transmission of the scheduling grant.

Aspect 18: The method of any of aspects 15 through 17, wherein the one or more performance indicators comprise a quantity of instances any triggering event of the plurality of triggering events are satisfied, a quantity of instances the DSR is triggered, a scheduling request success rate, an average quantity of scheduling request transmissions before transmitting a scheduling grant, a quantity of instances the DSR is canceled, an effective PDCP discard metric, or any combination thereof.

Aspect 19: A UE for wireless communications, comprising one or more memories storing processor-executable code, and one or more processors coupled with the one or more memories and individually or collectively operable to execute the code to cause the UE to perform a method of any of aspects 1 through 13.

Aspect 20: A UE for wireless communications, comprising at least one means for performing a method of any of aspects 1 through 13.

Aspect 21: A non-transitory computer-readable medium storing code for wireless communications, the code comprising instructions executable by one or more processors to perform a method of any of aspects 1 through 13.

Aspect 22: A network entity for wireless communications, comprising one or more memories storing processor-executable code, and one or more processors coupled with the one or more memories and individually or collectively operable to execute the code to cause the network entity to perform a method of any of aspects 14 through 18.

Aspect 23: A network entity for wireless communications, comprising at least one means for performing a method of any of aspects 14 through 18.

Aspect 24: A non-transitory computer-readable medium storing code for wireless communications, the code comprising instructions executable by one or more processors to perform a method of any of aspects 14 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity of a serving cell of the UE, a delay status reporting configuration comprising an indication of a plurality of triggering events associated with delay status reporting for one or more logical channels of the UE; and
transmit, in accordance with the delay status reporting configuration, a report indicative of a delay status of a first logical channel of the one or more logical channels based at least in part on a first triggering event of the plurality of triggering events being satisfied, wherein the first triggering event is selected from the plurality of triggering events based at least in part on a radio condition associated with the UE, a traffic pattern associated with the first logical channel, or both.

2. The UE of claim 1, wherein the one or more processors are individually or collectively further operable to execute the code to cause the UE to:
monitor one or more performance indicators associated with the delay status reporting, wherein the one or more performance indicators comprise a quantity of instances wherein any triggering event of the plurality of triggering events is satisfied, a quantity of instances wherein the delay status reporting is triggered, a scheduling request success rate, an average quantity of scheduling request transmissions before receiving a scheduling grant, a quantity of instances the delay status reporting is canceled, an effective packet data convergence protocol (PDCP) discard metric, or any combination thereof.

3. The UE of claim 2, wherein the one or more processors are individually or collectively further operable to execute the code to cause the UE to:
transmit, in accordance with the monitoring, a second report indicative of the one or more performance indicators associated with the delay status reporting, wherein the delay status reporting configuration is received based at least in part on transmission of the second report.

4. The UE of claim 2, wherein the one or more processors are individually or collectively further operable to execute the code to cause the UE to:
train an artificial intelligence model at the UE based at least in part on the one or more performance indicators associated with the delay status reporting, wherein the first triggering event is selected from the plurality of triggering events based at least in part on the artificial intelligence model.

5. The UE of claim 1, wherein:
the delay status reporting configuration indicates a range of remaining time thresholds associated with a remaining time of a plurality of packet data convergence protocol (PDCP) timers associated with one or more service data units (SDUs) buffered for a logical channel group comprising the one or more logical channels of the UE, and
the first triggering event comprises a remaining time threshold of the range of remaining time thresholds selected by the UE based at least in part on the radio condition associated with the UE, the traffic pattern associated with the first logical channel, or both.

6. The UE of claim 1, wherein the first triggering event is associated with periodic transmission of the delay status reporting, and wherein, to transmit the report indicative of the delay status, the one or more processors are individually or collectively operable to execute the code to cause the UE to:
transmit the report indicative of the delay status of the first logical channel periodically based at least in part on the first triggering event of the plurality of triggering events being satisfied and based at least in part on a delay status reporting timer of the UE associated with the periodic transmission.

7. The UE of claim 1, wherein the traffic pattern comprises a traffic type of the first logical channel, bearer-specific data of the first logical channel, a quality of service (QoS) flow identifier (QFI) of a QoS flow of the first logical channel, or any combination thereof.

8. The UE of claim 1, wherein the first triggering event is associated with early indication of the delay status, and wherein, to transmit the report, the one or more processors are individually or collectively operable to execute the code to cause the UE to:
receive, from the network entity of the serving cell of the UE, a second delay status reporting configuration comprising a second indication of a second plurality of triggering events associated with the delay status reporting for a second logical channel of the UE, wherein the first logical channel and the second logical channel are of a same logical channel group.

9. The UE of claim 1, wherein, to transmit the report, the one or more processors are individually or collectively operable to execute the code to cause the UE to:
transmit the report indicative of the delay status of the first logical channel the report prior to multiple of the plurality of triggering events being satisfied based at least in part on the radio condition associated with the UE, the traffic pattern associated with the first logical channel, or both, wherein: the radio condition, the traffic pattern, or both are associated with an uplink grant pattern, a type of data arrival, a burstiness of the data arrival, one or more characteristics of a packet data unit (PDU) set, or any combination thereof.

10. The UE of claim 1, wherein the radio condition, the traffic pattern, or both are associated with a signaling procedure at the UE, a bearer type, or both.

11. The UE of claim 1, wherein, to transmit the report, the one or more processors are individually or collectively operable to execute the code to cause the UE to:
transmit the report indicative of the delay status of the first logical channel after a time delay based at least in part on the traffic pattern, wherein the traffic pattern comprises a medium access control (MAC)-control element (CE), upper-layer traffic in a MAC transport block (TB), or both associated with a higher priority level than a priority level of the report.

12. The UE of claim 1, wherein the report is transmitted via a first component carrier, and the one or more processors are individually or collectively further operable to execute the code to cause the UE to:
transmit, via a second component carrier, one or more retransmissions of the report indicative of the delay status of the first logical channel based at least in part on the radio condition associated with the UE, wherein the radio condition comprises a hybrid automatic repeat request (HARQ) block error rate (BLER) of the UE.

13. The UE of claim 1, wherein the report comprises a medium access control (MAC)-control element (CE).

14. A network entity, comprising:
one or more memories storing processor-executable code; and
one or more processors coupled with the one or more memories and individually or collectively operable to execute the code to cause the network entity to:
output a delay status reporting configuration comprising an indication of a plurality of triggering events associated with a delay status reporting for one or more logical channels of a user equipment (UE); and
obtain, in accordance with the delay status reporting configuration, a report indicative of a delay status of a first logical channel of the one or more logical channels based at least in part on a first triggering event of the plurality of triggering events being satisfied, wherein the first triggering event is selected from the plurality of triggering events based at least in part on a radio condition associated with the UE, a traffic pattern associated with the first logical channel, or both.

15. The network entity of claim 14, wherein the one or more processors are individually or collectively further operable to execute the code to cause the network entity to:
receive a second report indicative of one or more performance indicators associated with the delay status reporting, wherein outputting the delay status reporting configuration is based at least in part on receiving the second report.

16. The network entity of claim 15, wherein the one or more processors are individually or collectively further operable to execute the code to cause the network entity to:
train an artificial intelligence model based at least in part on the one or more performance indicators associated with the delay status reporting, wherein the delay status reporting configuration is based at least in part on the artificial intelligence model.

17. The network entity of claim 15, wherein the one or more processors are individually or collectively further operable to execute the code to cause the network entity to:
output a scheduling grant based at least in part on the one or more performance indicators, wherein the report is received based at least in part on transmission of the scheduling grant.

18. The network entity of claim 15, wherein:
the one or more performance indicators comprise a quantity of instances
any triggering event of the plurality of triggering events are satisfied, a quantity of instances
the delay status reporting is triggered, a scheduling request success rate, an average quantity of scheduling request transmissions before transmitting a scheduling grant, a quantity of instances the delay status reporting is canceled, an effective packet data convergence protocol (PDCP) discard metric, or any combination thereof.

19. A method for wireless communications at a user equipment (UE), comprising:
receiving, from a network entity of a serving cell of the UE, a delay status reporting configuration comprising an indication of a plurality of triggering events associated with delay status reporting for one or more logical channels of the UE; and
transmitting, in accordance with the delay status reporting configuration, a report indicative of a delay status of a first logical channel of the one or more logical channels based at least in part on a first triggering event of the plurality of triggering events being satisfied, wherein the first triggering event is selected from the plurality of triggering events based at least in part on a radio condition associated with the UE, a traffic pattern associated with the first logical channel, or both.

20. The method of claim 19, further comprising:
monitoring one or more performance indicators associated with the delay status reporting, wherein the one or more performance indicators comprise a quantity of instances wherein any triggering event of the plurality of triggering events is satisfied, a quantity of instances wherein the delay status reporting is triggered, a scheduling request success rate, an average quantity of scheduling request transmissions before receiving a scheduling grant, a quantity of instances the delay status reporting is canceled, an effective packet data convergence protocol (PDCP) discard metric, or any combination thereof.
